(19) United States
(12) Patent Application Publication
(10) Pub. No.: US 2015/0029737 A1
(43) Pub. Date: Jan. 29, 2015

(54) DAYLIGHT INPUT IN AIRCRAFT

(71) Applicant: Airbus Operations GmbH, Hamburg (DE)

(72) Inventors: Werner Granzeier, Jork (DE); Torsten Kanitz, Holm (DE); Alexander Berschin, Hamburg (DE); Hasko Rose, Hamburg (DE); Oliver Doebertin, Hamburg (DE); Florian Schmidt, Hamburg (DE)

(73) Assignee: AIRBUS OPERATIONS GMBH, Hamburg (DE)

(21) Appl. No.: 14/511,876

(22) Filed: Oct. 10, 2014

Related U.S. Application Data
(63) Continuation of application No. PCT/EP2013/057730, filed on Apr. 12, 2013.
(60) Provisional application No. 61/623,657, filed on Apr. 13, 2012.

(30) Foreign Application Priority Data
Apr. 13, 2012 (DE) 10 2012 007 473.5

(51) Int. Cl. F21S 11/00; B64D 11/00; F21V 8/00; B64C 1/14

(52) U.S. Cl. CPC F21S 11/002; B64C 1/1484; B64D 11/00; G02B 6/0001; B64D 2011/0038
USPC 362/471

(57) ABSTRACT

An aircraft with a daylight input system may provide improved illumination with a reduced energy demand. The aircraft has a fuselage construction and at least one interior area arranged within the fuselage construction and includes the daylight input system. The daylight input system includes at least one light receiving device arranged in an outer wall, at least one light guiding device and at least one light emitting device arranged on the inner side. In this case, the light receiving device serves for receiving daylight present in the surrounding outside the outer wall and transmitting the same into the light guiding device. The light guiding device optically couples the light receiving device to the light emitting device. This light emitting device in turn emits the received daylight into an interior space on the inner side of a wall construction, wherein at least a partial deflection of the daylight is provided.

### CROSS-REFERENCE TO RELATED APPLICATION

The present application is a continuation of International Application No. PCT/EP2013/057730, filed Apr. 12, 2013, which claims priority from German Patent Application No. 10 2012 007 473.5, filed Apr. 13, 2012, and which claims the benefit of the filing date of U.S. Provisional Patent Application No. 61/623,657, filed Apr. 13, 2012, the disclosure of which applications is hereby incorporated herein by reference.

### FIELD OF THE INVENTION

The present invention relates to the daylight input for aircraft and, in particular, an aircraft with a daylight input system, a method for utilizing daylight in the interior of an aircraft and the use of a daylight input system in an aircraft.

### BACKGROUND OF THE INVENTION

In order to provide a desired brightness in interior spaces of aircraft, artificial light sources are provided within the cabin space, which light sources can be activated on demand. In aircraft for the transport of passengers, such as airliners, additional light is also required in the cabin interior space at sufficient brightness in the surrounding because the available window openings are not only relatively small, but also arranged relatively low referred to the cabin interior space, since they predominantly serve for the view of the passengers and therefore are arranged at the height of the passenger's head or slightly thereunder such that the passenger can look down to the earth during the flight. It is generally known that the size of the window openings is limited for static reasons. In air freighters that typically do not comprise any window openings except in the cockpit, artificial light is provided for sufficient illumination, particularly during loading and unloading processes. In passenger aircraft, in particular, additional light sources are also required for the duration of the flight in daytime for comfort reasons while only reduced illumination of the cabin interior is required in the nighttime, at least during the majority of the flying time. The required light sources in the cabin interior consist of electrically operated artificial light sources. The increased demands with respect to the quality of the time spent in the cabin area have also caused the demand for additional light sources to increase beyond the necessary safety amount. However, it has been shown that this is associated with a significant power demand, namely even if modern lamps are used, wherein this power demand needs to be provided aboard the aircraft. For this purpose, separate generator devices need to be operated or the on-board generators that are connected to the aircraft turbines or other propulsion devices need to supply the correspondingly increased power. However, this means additional weight, in particular, due to the fuel to be stored for this purpose. The additional light sources require significant extra effort with respect to their installation and wiring and also mean an increase in weight.

### BRIEF SUMMARY OF THE INVENTION

An aspect of the present invention may provide an improved illumination with a reduced energy demand.

According to an aspect of the invention, an aircraft with a fuselage construction, at least one interior area arranged within the fuselage construction and a daylight input system is provided. The daylight input system comprises at least one light receiving device arranged in an outer wall, at least one light guiding device and at least one light emitting device arranged on the inner side. The light receiving device is designed to receive daylight present in the surrounding outside an outer wall and transmit the same into the light guiding device. The light guiding device optically couples the light receiving device to the light emitting device. The light emitting device is designed to emit the daylight into an interior space on an inner side of a wall construction, wherein at least a partial deflection of the daylight takes place.

In this way, an improved illuminating situation is made available that has a reduced energy demand and therefore provides economical and ecological advantages for the operation of the aircraft.

The term “aircraft” refers, in particular, to airplanes, e.g. airliners. Furthermore, this term also refers to helicopters or airships.

The interior space consists, for example, of a cabin area or cabin interior space. However, the term interior space may also refer to secondary rooms or room segments within the aircraft, e.g. separated sanitary zones or sleeping zones for the crew.

The term “emitting daylight” comprises, for example, the emission of light into the interior space or onto surrounding surfaces of the interior space or surfaces within the cabin area. In any case, daylight is made available to the interior space.

The light receiving device is arranged, for example, on an outer side of the outer wall. The light receiving device may also be referred to as light capturing device and the light emitting device may also be referred to as light discharging device.

The daylight input system may comprise several light receiving devices, wherein a light receiving device may also comprise several individual light receiving elements. Furthermore, several light guiding devices may also be provided and one light guiding device may comprise several light guiding elements. Further, several light emitting devices may also be provided and one light emitting device may comprise several light emitting elements.

According to an exemplary embodiment, the light guiding device of the daylight input system extends in a wall construction between the outer side and the inner side of the fuselage construction. For example, the light receiving device and the light emitting device are arranged offset to one another.

In this way, daylight can be made available at suitable locations. The reception or capture of light can be realized at constructively favorable locations, wherein this primarily refers to the fuselage being subjected to very high static loads during flight operations and any opening in the hull must be adapted to the static assemblage. Due to the offset of light reception and light emission, the most favorable positions can be respectively used.

For example, the light emission takes place offset to the window surfaces. According to an example, the light emission is provided above cabin windows.

According to an exemplary embodiment, a window construction is inserted into an opening of the outer wall and the light receiving device is arranged in the opening.

The combination not only means advantages with respect to space requirement and installation, but also minimizes additional weight caused by the daylight input system. Another important consideration can be seen in that the integrative design in the outer skin makes it unnecessary to take any other sealing measures, because in aircraft design besides the seal against moisture and wind, also very high pressure differentials occur between the surroundings and the cabin space.

For example, the light receiving device is integrated into a window construction.

According to an exemplary embodiment, the window construction comprises an outer receiving surface that is larger than a look-through surface of the window by a projecting area, wherein the light receiving device is provided in the projecting area.

In this way, the extra effort for the utilization of daylight is reduced to a minimum; for example, the same size of opening in the fuselage can be utilized, but the transparent area of the window that predominantly serves for the view of the passengers can be realized slightly smaller.

The light receiving device is arranged, for example, outside the look-through or transparent area.

The window construction comprises, for example, an enlarged outer pane, wherein the light receiving device is arranged behind the enlarged outer pane.

For example, the opening of the outer wall is utilized to a certain extent for the light receiving device of the daylight input system and to a far greater extent for the window function, i.e. the opportunity of a view from the cabin.

According to an exemplary embodiment, the light receiving device of the daylight input system couples a first portion of the incident daylight into the light guiding device and a second portion of the incident daylight reaches the interior through the window opening.

For example, a semi-prism is provided in the border region of a window and indeed couples a largest possible portion of the incident daylight possible into the light guiding device, i.e. does not allow this daylight to be directly incident into the cabin space, but also enables a portion of the daylight to reach the interior such that the optical effect creates the impression of a larger window opening.

For example, the light receiving device and the light guiding device are realized in the form of a lens construction, e.g. with reflection surfaces, in order to guide daylight onto a surface to be illuminated.

According to an exemplary embodiment, the light receiving device of the daylight input system is arranged in lateral border areas of adjacent windows, wherein a rib extends vertically between the windows. The light emitting device is arranged on the inner side in front of the rib.

The area in front of the rib therefore receives light from the right side and from the left side. The light guiding device extends, for example, in the horizontal direction of the fuselage and/or also in the vertical direction. The light receiving devices may be arranged laterally of the window, wherein the light guiding device extends, for example, vertically upward and the light emitting device is arranged above the window. The light receiving device is arranged, for example, in the area around the window, wherein the light emission is realized above and/or below the window.

The light guiding device may comprise, for example, flexible optical fibers and may be adapted to an aircraft contour. The adaptation also includes bypassing structural components, because the cabin walls usually have a compact and dense wall structure with relatively high complexity. The light guiding device comprises, for example, optical fibers, prisms and/or mirrors. The light guiding device may be angled several times. The light guiding device may also be realized such that it can be focused. For example, the light guiding device is applied particularly thin and has a low weight. The light guiding device preferably absorbs as little energy as possible.

In another example, the light guiding device is realized such that it can be a dimmed in order to provide enhanced user comfort.

The light guiding device may comprise a junction in order to couple incident light into a device for so-called Energy Harvesting, i.e. for guiding the light to photovoltaic elements in order to locally generate electric energy for a local consumer, e.g. a control or measuring device or an actuating element accommodated in the wall construction.

According to an exemplary embodiment, the light emitting device of the daylight input system forms a concealed light source.

The term “concealed” refers, e.g. to the light source not being visible to a user such as, for example, the passenger and only the surface irradiated or illuminated by the light output unit being visible.

The light output unit is realized with a feed unit for feeding the light into a panel light. For example, the panel light may be additionally utilized as a backlit advertising area.

According to an exemplary embodiment, the light emitting device of the daylight input system comprises a light output unit that can be closed with a cover element.

For example, the cover element is a lining segment that can be slided by a passenger.

According to an exemplary embodiment, the light emitting device of the daylight input system comprises a light output unit, wherein an artificial light source is provided such that the artificial light source can emit artificial light into the interior space via the light output unit.

The input of daylight may be coupled with the irradiation of artificial light. For example, the emission of daylight and the emission of artificial light are realized in a superimposed fashion. The emission of daylight and the emission of artificial light may also be realized in adjacent areas of the light emitting device.

The light output unit may comprise, for example, a reflection area that can be irradiated with the fed in daylight in order to illuminate the interior space. The reflection area may also be irradiated with artificial light in order to illuminate the interior space.

The light emitting device may comprise, for example, a translucent surface that is irradiated with fed in daylight from the rear. For example, the translucent surface can also be irradiated with artificial light on the rear side. The terms “rear” and “rear side” respectively refer to the surface that faces away from the cabin space.

The reflection area may consist of a surface that is arranged above passenger seats such as, for example, an underside of a passenger supply unit (PSU).

The artificial light source may be arranged such that it is invisible to the user.

The light guiding device comprises, for example, at least one light guiding element such as a light guiding with a reflective coating on its inner side.

According to an exemplary embodiment, the light emitting device of the daylight input system is arranged above a window.

The light emitting device may be arranged, for example, in a wall paneling above the window or above the window framing. The light emitting device may also be integrated into the window frame lining.

According to an exemplary embodiment, the transmission of daylight through the window opening can be controlled independently of the emission of daylight by the light emitting device.

For example, the window can be covered with an obscuration element that has no influence at all on the daylight input in its different positions. The obscuration element may also consist of a pane, the light transmittance (transmittance) of which can be controlled, e.g. a pane of electrochromic glass, LC-glass (liquid-crystal glass) or PDLC-glass (polymer-dispersed-liquid-crystal glass).

According to an exemplary embodiment, the light emitting device of the daylight input system is arranged in the interior such that an inner side of the outer wall can be irradiated with the light to be emitted.

For example, the light emitting device is arranged on an underside of an overhead luggage compartment and the luminous radiation to be emitted is projected in the direction of the lateral wall surface onto the wall regions above the window.

According to an exemplary embodiment, a window construction is inserted into an opening of the outer wall and the light receiving device is arranged in an expansion of the opening.

The expansion may be arranged, for example, above the window opening and be significantly smaller than the window opening, e.g., such that it only amounts to no more than 25% or 10% of the size of the window opening.

According to an exemplary embodiment, the light receiving device of the daylight input system comprises at least one light receiving opening in the enveloping surface, through which opening the daylight reaches the light guiding device arranged on the inner side.

The at least one light receiving opening may be arranged on the upper side of a fuselage construction. For example, the at least one light receiving opening is centrally arranged in the crown or apex area of the fuselage, wherein the light guiding device laterally deflects the daylight, and wherein the light emitting device is arranged laterally offset referred to the light receiving opening.

The light emitting device may be arranged, for example, above aisle areas. The light emitting device is arranged, e.g., in the ceiling area of entrance/exit zones.

According to an exemplary embodiment, the light receiving device of the daylight input system comprising at least one projection that protrudes from the outer side of the aircraft.

For example, the light receiving device features at least one fin that extends in the longitudinal direction on the outer side of the fuselage, wherein the fin has a receiving surface that is larger than a contact surface of the fin on the outer wall surface.

According to an exemplary embodiment, the outer wall comprises a plurality of embedded optical waveguides that protrude from the outer side to the inner side of the enveloping surface and that couple the daylight into the light guiding device.

For example, optical fibers extending transverse to the enveloping surface are provided in the wall construction, i.e., in the fuselage hull. The direction, in which the fibers extend, may vary, for example, in dependence on their position on the fuselage.

In a multilayer structure, a plurality of light guiding elements may be provided in each layer such that the light guiding elements of adjacent layers at least partially overlap one another and a light transmission from the outside toward the inside can be realized. In a GLARE-construction (glass-fiber reinforced aluminum), for example, a plurality of embedded glass fiber segments is provided in each of the layers.

According to an exemplary embodiment, the light receiving device of the daylight input system comprising at least one light guiding film, wherein the film is connected to at least one optical coupling device that couples the light from the film into the light guiding device.

According to another of the invention, a method for utilizing daylight in the interior of an aircraft is proposed, wherein the method comprises the following steps:
a) receiving and transmitting daylight present in the surrounding outside an outer wall into the light guiding device with by a light receiving device;
b) guiding the received light to a light emitting device, and
c) emitting the daylight into an interior space on an inner side of the outer wall,
   wherein at least a partial deflection of the daylight takes place.

According to yet another aspect of the invention, the use of a daylight input system according to one of the above-described exemplary embodiments in an aircraft is also provided. The inventive daylight input system features the characteristics of one or several of the above-described examples.

According to still further aspect of the invention, it is provided that a further portion of daylight can reach the interior space of an aircraft in addition to the daylight incident through the window surfaces that are relatively small for construction-related reasons. For this purpose, a “collection” of daylight in the surroundings is also carried out, for example, in connection with the already provided window openings in the fuselage construction and the collected daylight is then guided to corresponding locations within the cabin of light guiding elements such that additional daylight is available at these locations. For example, the lateral wall surfaces of the windows or even a slight expansion of the window openings can be used for the daylight input into the system. In addition, it would also be possible to slightly reduce the actual window construction, i.e., the look-through surface, in order to provide a surface area, in which the daylight is fed into the daylight system. Different concepts may be considered for the emission of the light into the interior. For example, an emitting device may be accommodated in the cabin wall panels or ceiling panels similar to an artificial light source, wherein these emitting devices subsequently have the appearance of luminous or light-emitting areas. In addition, daylight from the daylight input system can also be used for irradiating areas that subsequently emit light into the interior, for example, through light-diffusing surfaces in the form of luminous areas. According to another exemplary concept, translucent surfaces can also be irradiated with the fed in daylight from the rear in order to have the appearance of bright areas or surface areas of the cabin hull. For example, the surfaces or areas for the light emission may be arranged above the window areas and, in particular, above the passenger areas in order to distribute the additionally fed in daylight within the cabin area in the best possible fashion. In addition to the combination with window openings, it would also be possible to provide other openings that, however, are only relatively small due to the supporting function of the fuselage construction and to utilize these openings for respectively feeding daylight from the surroundings into the aircraft or into a daylight input system. For example, devices with an enlarged surface may be provided for collecting the daylight in order to subsequently guide the daylight into the fuselage construction in a collimated fashion by a highly compact optical waveguide such that the stability of the fuselage construction respectively is only negligibly weakened or not impaired. For example, daylight to be subsequently fed into the fuselage construction can be collected in a particularly efficient fashion in the apex area of the fuselage construction. However, since central supply lines are frequently arranged in this region, the light cannot be directly emitted into the interior at these locations, but rather is laterally deflected by light redirecting measures in order to be subsequently emitted into the interior in an offset fashion.

According to another aspect of the invention, the utilization of the fed in daylight represents an energy-saving measure because it reduces the demand for artificial light. In addition to the illuminating function, however, it also becomes possible to create a light situation in the cabin area that at least partially reflects the predominant light situation outside the aircraft. In connection with the combination with artificial light, excessive fluctuations outside the aircraft can be at least somewhat dampened, but still projected into the interior in such a way that the passenger experiences enhanced comfort and well-being. In addition, the utilization of daylight represents another component of the cabin equipment and therefore expands the corporate image of an airline. It should ultimately also be noted that the utilization of daylight typically involves a certain rhythm, dynamic or light color as well such that largely natural light conditions that are adapted to the so-called natural rhythm and capable of supporting the phases of human performance are made available in the interiors of aircraft, particularly passenger aircraft, wherein this is also associated with physical health and well-being, as well as motivation, but these particular aspects are not discussed in greater detail. In this case, particularly the varying light color of the fed in daylight leads to a comfort enhancement for the user.

It should be noted that the characteristics of the exemplary embodiments and aspects of the devices or of the aircraft, as well as of the daylight input system, also apply to embodiments of the method and of the utilization of the system and vice versa. In addition, it is also possible to freely combine characteristics, in reference to which this is not explicitly mentioned.

### BRIEF DESCRIPTION OF THE DRAWINGS

Exemplary embodiments of the invention are described in greater detail below with reference to the attached drawings. In these drawings:

FIG. 1 shows a cross section through an aircraft according to an example of the invention;

FIG. 2 shows a section through a fuselage construction of an aircraft with a daylight input system according to an example of the invention;

FIG. 3 shows a perspective representation of the constructive design of an exemplary embodiment of the daylight input system viewed from the outer side of the fuselage;

FIG. 4 shows the daylight input system according to FIG. 3 viewed from the cabin area;

FIG. 5 shows a view of an inner cabin wall with several daylight input systems according to FIG. 3 and FIG. 4;

FIG. 6 shows a perspective representation of another exemplary embodiment of the daylight input system viewed from outside;

FIG. 7 shows the daylight input system according to FIG. 6 viewed from inside;

FIG. 8 shows an inside view of a cabin wall region with several daylight input systems according to FIG. 6 and FIG. 7;

FIG. 9 shows a perspective inside view of another exemplary embodiment of the daylight input system;

FIG. 10 shows a sectional representation of the daylight input system according to FIG. 9;

FIG. 11 shows a cabin wall region with several daylight input systems according to FIG. 9 and FIG. 10;

FIG. 12 shows a perspective functional drawing of another exemplary embodiment of the daylight input system;

FIG. 13 shows an inner wall region with several daylight input systems according to FIG. 12;

FIG. 14 shows another exemplary embodiment of the daylight input system according to FIG. 13;

FIG. 15 shows another exemplary embodiment of the daylight input system in the form of a horizontal section through a wall region;

FIG. 16 shows another exemplary embodiment of the daylight input system in the form of an inside view of the cabin wall;

FIG. 17 shows a perspective outside view of another exemplary embodiment of the daylight input system;

FIG. 18 shows a vertical section through the daylight input system according to FIG. 17;

FIG. 19 shows a detail of the daylight input system according to FIG. 18;

FIG. 20 shows a perspective outside view of another exemplary embodiment of the daylight input system;

FIG. 21 shows a vertical section through a fuselage construction with the daylight input system according to FIG. 20;

FIG. 22 shows a schematic functional drawing of the daylight input system according to FIG. 21;

FIG. 23 shows a perspective outside view of another exemplary embodiment of the daylight input system;

FIG. 24 shows a perspective inside view of the daylight input system according to FIG. 23;

FIG. 25 shows another exemplary embodiment of the daylight input system in the form of a cross-sectional representation of an aircraft fuselage (section);

FIG. 26 shows a cabin wall region with a plurality of daylight input systems according to FIG. 25;

FIG. 27 shows a perspective outside view of another exemplary embodiment of the daylight input system;

FIG. 28 shows another perspective view of the construction of the daylight input system according to FIG. 27;

FIG. 29 shows a perspective inside view of a cabin wall with the daylight input system according to FIG. 27 and FIG. 28;

FIG. 30 shows another exemplary embodiment of the daylight input system in the form of an oblique top view of a fuselage construction;

FIG. 31 shows the schematic principle of the daylight input system according to FIG. 30;

FIG. 32 shows another construction drawing in the form of a perspective view of the daylight input system according to FIG. 30 and FIG. 31;

FIG. 33 shows a construction drawing in the form of a perspective view of FIG. 30;

FIG. 34 shows another exemplary embodiment of the daylight input system in the form of a cross-sectional representation (section of the fuselage in the upper area);

FIG. 35 shows another exemplary embodiment of the daylight input system in the form of a schematic cross section (section) through a fuselage area;

FIG. 36 shows another exemplary embodiment of the daylight input system in the form of a representation of the inner cabin wall;

FIG. 37 shows an example of a method for utilizing daylight in the interior of an aircraft;

FIG. 38 shows a rendered illustration of FIG. 4;

FIG. 39 shows a rendered illustration of FIG. 5;

FIG. 40 shows a rendered illustration of FIG. 8;

FIG. 41 shows a rendered illustration of FIG. 11, and

FIG. 42 shows a rendered illustration of FIG. 26.

### DETAILED DESCRIPTION

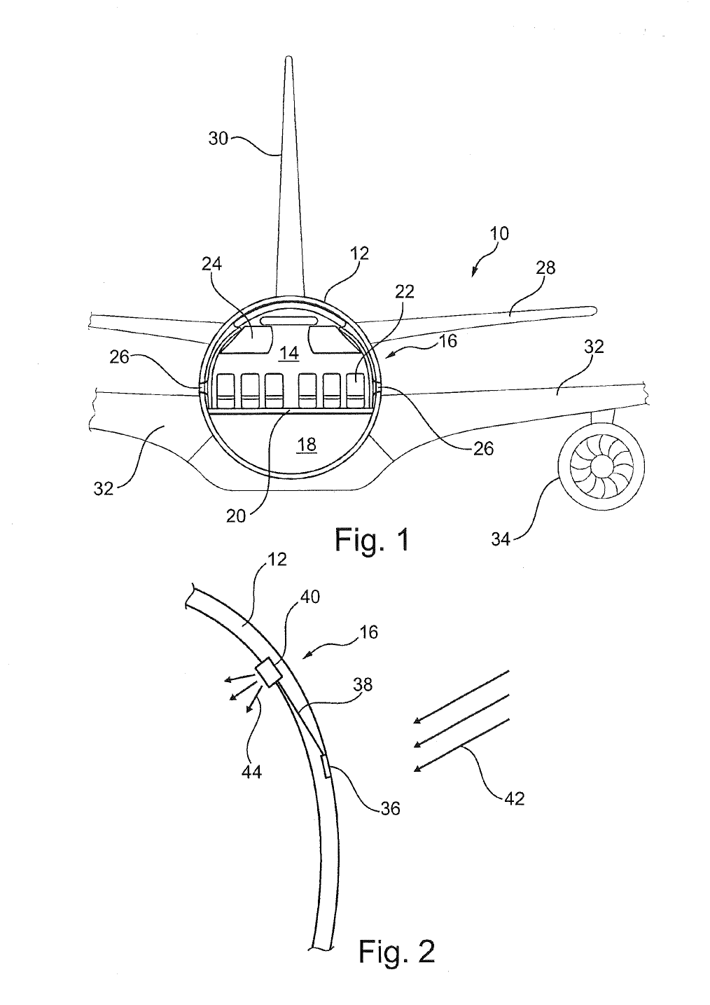

FIG. 1 shows an aircraft 10 with a fuselage construction 12 and at least one interior area 14 that is arranged within the fuselage construction, as well as a daylight input system 16 that is not illustrated in greater detail in FIG. 1, but described below in the form of different exemplary embodiments with reference to the following figures. FIG. 1 schematically indicates that the fuselage area enclosed by the peripheral wall construction may not only feature the interior area 14, but also an area 18 that is arranged underneath this interior area and serves, e.g., for accommodating pieces of luggage. The two areas are separated from one another by a floor 20, above which passenger seats 22 are schematically indicated. For example, luggage compartments 24 are situated above the passenger seats 22. In addition, lateral windows 26 arranged at the height of the passengers are also indicated in the fuselage construction 12. An elevator unit 28 arranged in the tail area of the aircraft and a rudder unit 30 are also indicated in this figure. In connection with a likewise illustrated wing arrangement 32 and a corresponding engine 34, FIG. 1 indicates that the aircraft 10 consists, for example, of an airliner.

FIG. 2 schematically shows a section of the fuselage construction 12. The inventive daylight input system 16 features at least one light receiving device 36 that is arranged in an outer wall and at least one light guiding device 38. In addition, the daylight input system 16 features at least one light emitting device 40 arranged on the inner side. The light receiving device 36 is designed for transmitting the received daylight from the outside surroundings to the light guiding device 38. The daylight is indicated with a first arrow structure 42. The light guiding device 38 optically couples the light receiving device 36 to the light emitting device 40, wherein it should be noted that this is only schematically indicated with a connecting line in FIG. 2. The light emitting device 40 is designed for emitting the daylight into an interior area on an inner side of a wall construction as symbolically indicated with a second arrow structure 44. In this case, at least a partial deflection of the daylight takes place.

According to an example, the light guiding device 38 extends in a wall construction, i.e., in the fuselage construction 12, between the outer side and the inner side and the light receiving device 36 and the light emitting device 40 are arranged offset to one another as indicated in an exemplary fashion in FIG. 2. For example, the light emission takes place offset to the window surfaces such as, e.g., in areas above cabin windows as illustrated in an exemplary fashion in the following figures.

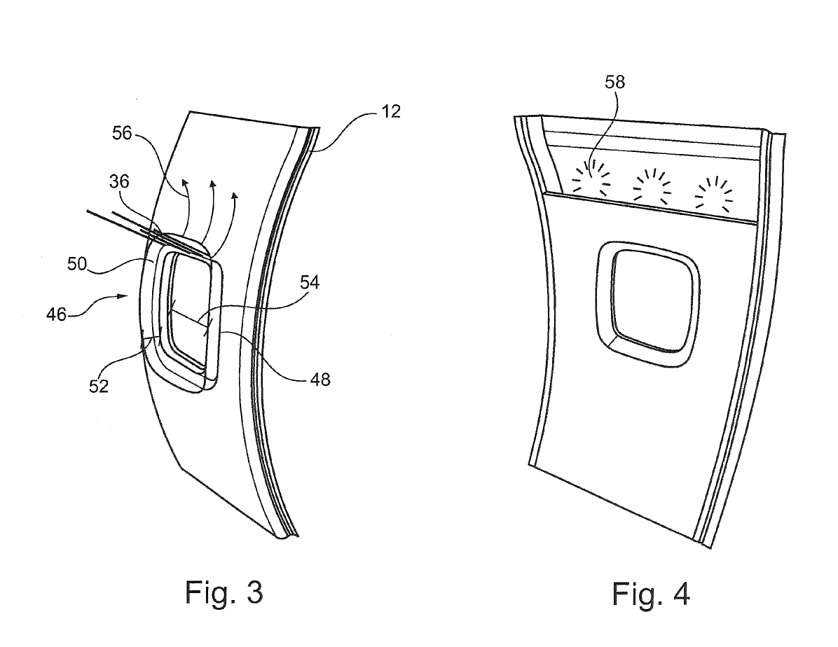

FIG. 3 shows an exemplary embodiment, in which a window construction 46 is inserted into an opening 48 of the outer wall, e.g. of the fuselage construction 12, wherein the light receiving device 36 is arranged in the opening. For example, the light receiving device 36 is integrated into a window construction. According to FIG. 3, the window construction may feature an outer receiving surface 50 that is larger than a look-through surface 54 of the window by a projecting area 52. The light receiving device 36 may be arranged, for example, in the projecting area 52.

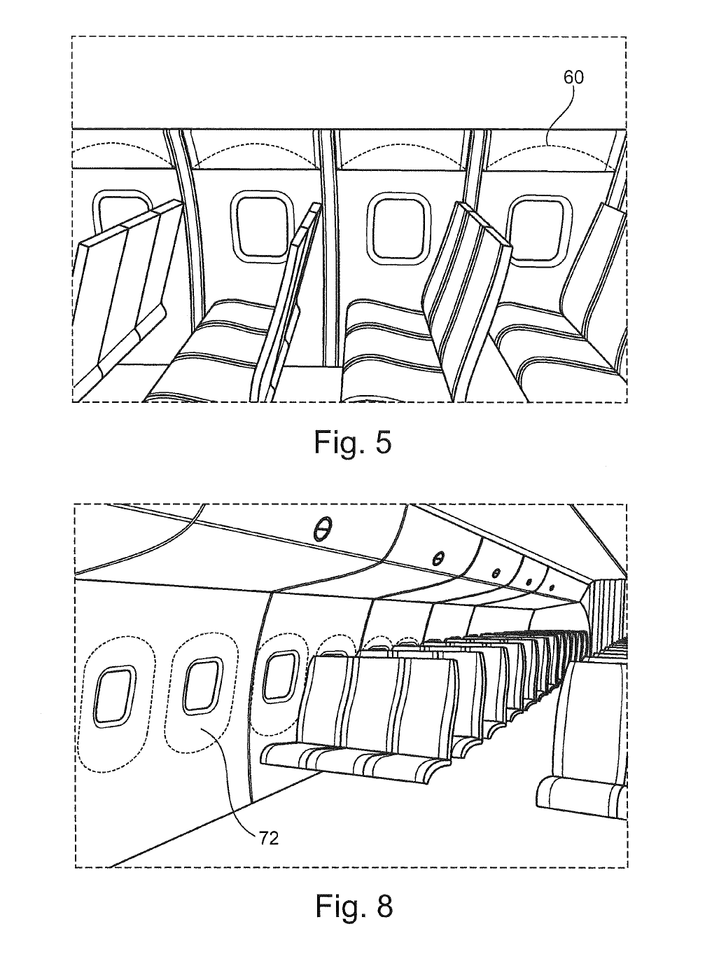

FIG. 4 shows the construction according to FIG. 3 in the form of a view from the interior. The quantity of daylight received or captured by the light receiving device 36 such as, for example, lenses or mirrors constructions is deflected upward as indicated with another arrow structure 56 in FIG. 3. According to FIG. 4, this deflected quantity of daylight is incident on and illuminates a cabin wall region in visible areas 58. For example, this cabin wall region may be arranged offset to the remaining paneling in the region of the window such that an illuminated area 60 results above the window as illustrated in an exemplary fashion in FIG. 5 in the form of a view of the inner wall over several window areas.

According to an exemplary embodiment that is not shown in greater detail, the light receiving device 36 is realized in such a way that a first portion of the incident daylight is coupled into the light guiding device and a second portion of the incident daylight reaches the interior through the window opening. For example, a semi-prism is provided for this purpose and arranged in the edge region of the window such that the impression of a larger window opening is created at this location although the direct transparency, i.e., the transparent area, is slightly restricted due to the utilization of daylight.

The light receiving device 36 may also be realized peripherally in the form of individual light receiving elements 62 such that a wall region 64 can be irradiated with fed in daylight from the rear peripherally around the window opening. It should be noted that FIG. 6 shows the construction in the form of a schematic design with a window opening 66, a peripheral frame construction 68 and an inwardly widening reveal 70; the outer cover of the fuselage or the fuselage construction itself is not illustrated in greater detail.

FIG. 7 shows the wall construction according to FIG. 6 in the form of a view from the interior. The area 64 illuminated from the wall interior has the appearance of a bright cabin wall region 72 and leads to an altogether improved light situation in the cabin space.

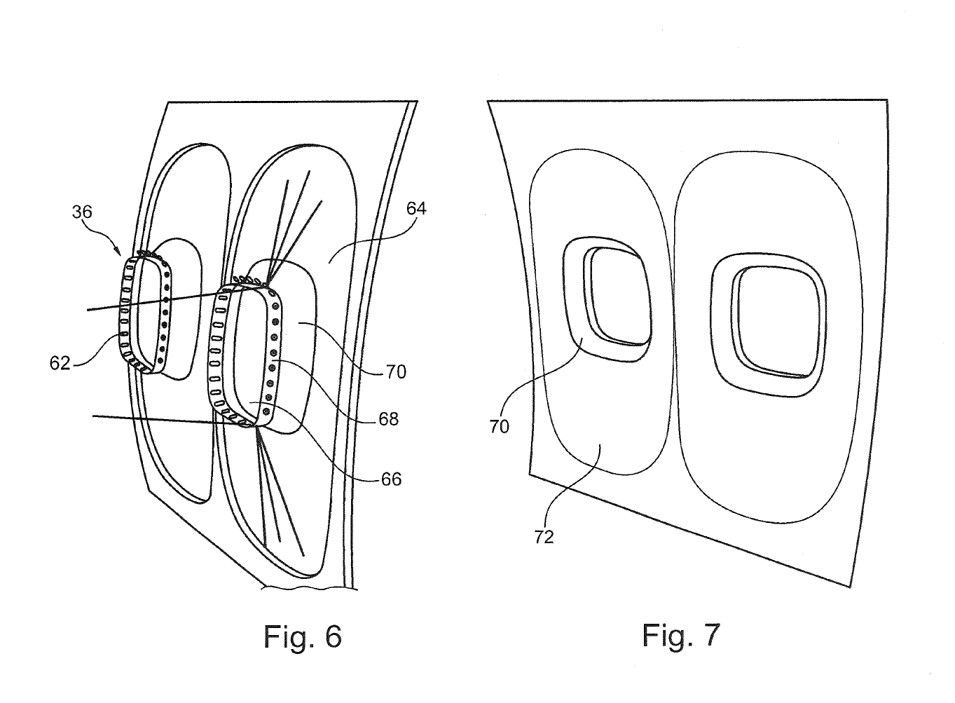

FIG. 8 shows several such wall regions 72 that are illuminated from the interior adjacent to one another. The cabin wall region illuminated from the interior consists, for example, of a translucent fabric or of a translucent membrane or lining that is able to emit the light transmitted from the interior into the cabin space in a diffused fashion.

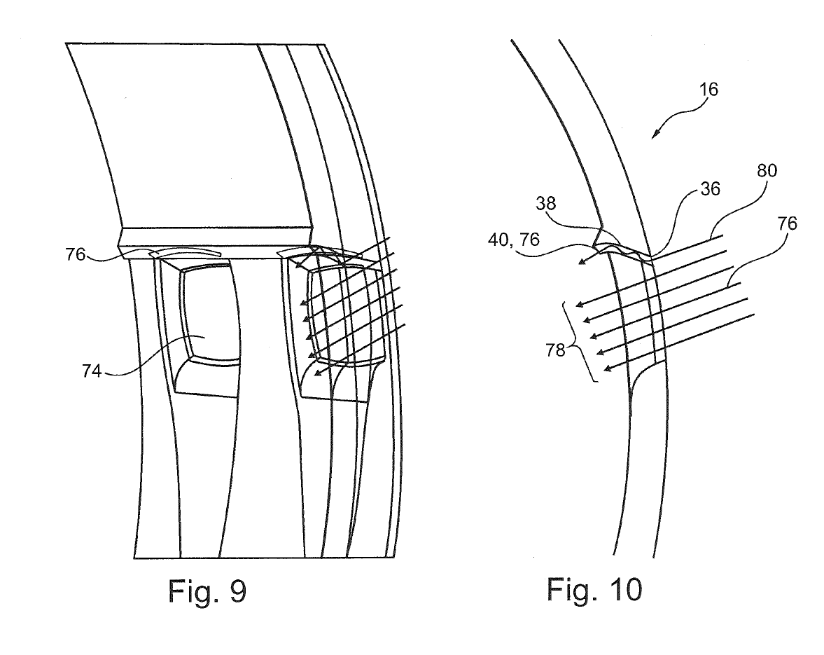

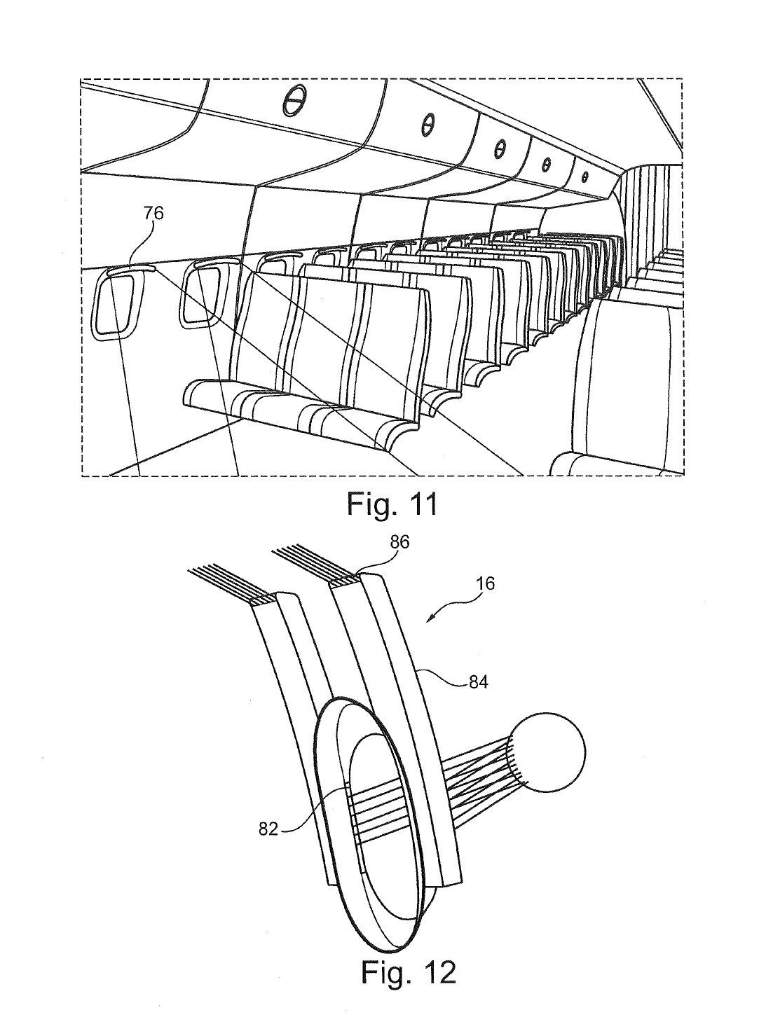

FIG. 9 shows another exemplary embodiment, in which a linear light emitting element 76 is arranged above a window arrangement 74, in the form of another inside view of a wall region. The corresponding vertical section is illustrated in FIG. 10. A first arrow structure 76 symbolizes the incident daylight, a first portion 78 of which directly reaches the interior through the window opening 74. A second portion 80 also reaches the interior, however, offset to the window opening by the daylight input system 16, i.e., the light receiving device 36, the light guiding device 38 and the light emitting device 40 in the form of the light emitting element 76. This makes it possible, for example, to transmit daylight farther into the interior as illustrated in FIG. 11. In addition, it is also possible, for example, to darken the window opening that is respectively situated in the immediate vicinity of the passenger sitting adjacent thereto or this passenger's field of vision and to still emit sufficient daylight into the interior by the daylight input system 16.

FIG. 12 shows another exemplary embodiment of a daylight input system 16, in which the light receiving device 36 consists of laterally arranged areas 82 that transmit the daylight to vertically extending light guiding device segments 84. The emission of the daylight into the interior takes place on upper ends 86.

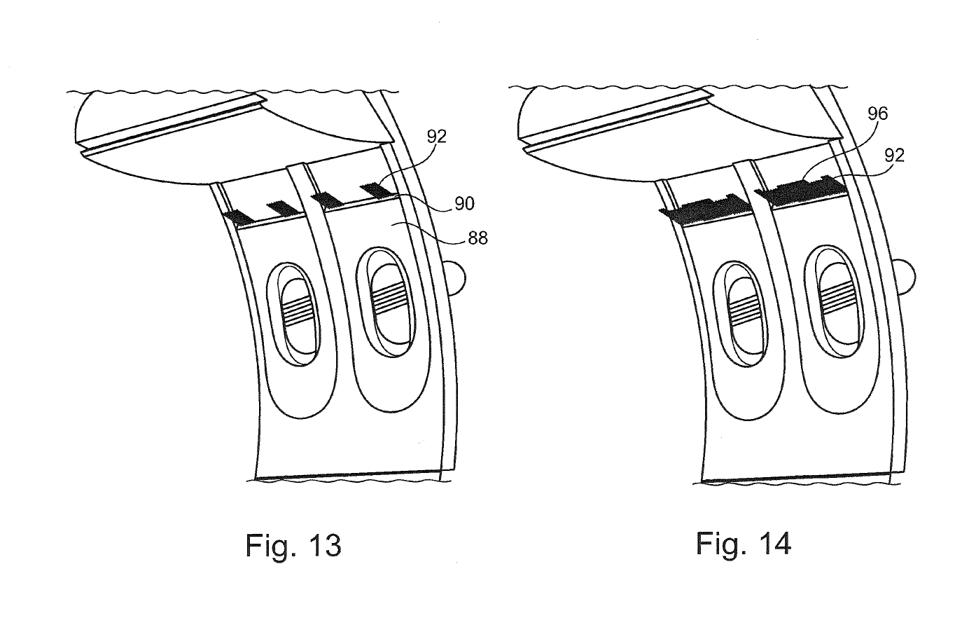

FIG. 13 shows the construction according to FIG. 12 with an additional inner wall paneling 88 that in a region 90 above the window openings comprises a horizontal area, in which the daylight indicated with an arrow structure 92 is emitted into the interior. Although the daylight input is only realized laterally of the windows in the vertical direction, the region 90 is still realized continuously. For example, an additional artificial light source 94 that is not illustrated in greater detail may be provided in this region such that artificial light indicated with a second arrow structure 96 in FIG. 14 can also illuminate the interior as a supplement to the daylight 92.

In the utilization of daylight according to FIG. 12 and FIG. 13, it is possible, for example, to close the window area with a (not-shown) panel that can be displaced, particularly upward, independently of the daylight utilization because a daylight deflection does not take place in this region, but rather only laterally of the window areas.

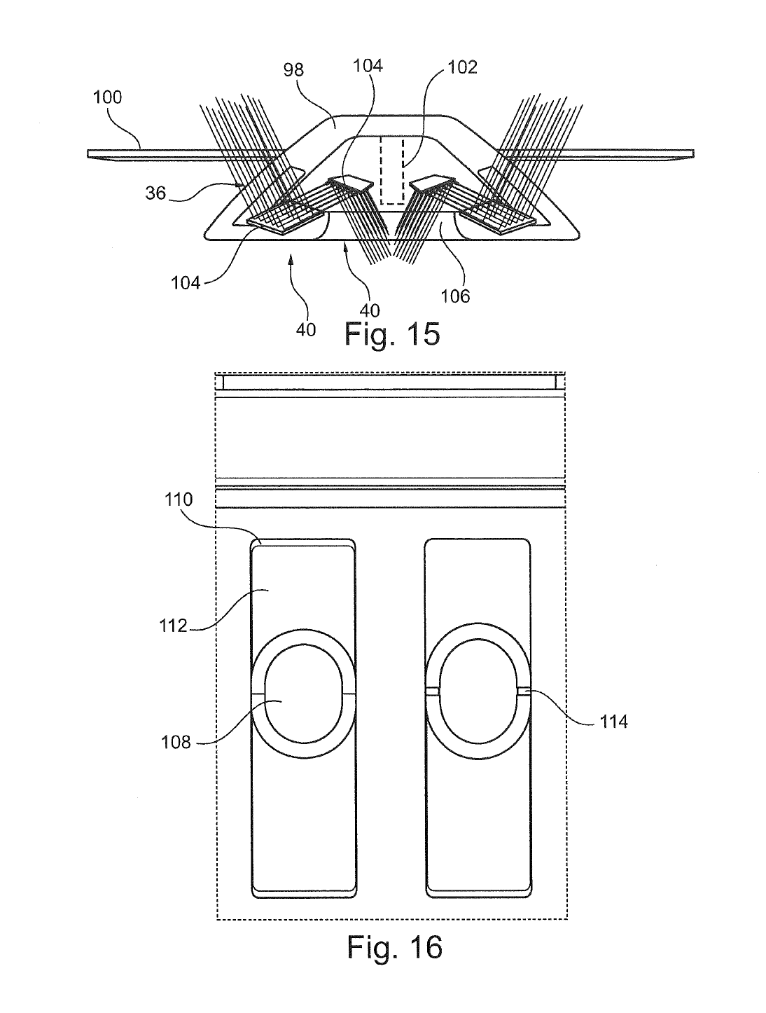

According to the exemplary embodiment illustrated in the form of a horizontal section in FIG. 15, the light receiving device 36 is arranged in lateral border areas 98 of adjacent windows that, without consideration of the multilayer design, are merely indicated in the form of a respective single pane 100. A rib that is indicated with a broken line 102 is provided extends in the vertical direction and is arranged between the windows. The light emitting device 40 is arranged on the inner side in front of the rib. The light guiding device 38 consists, for example, of two respective mirror segments 104. In this way, a cabin wall region can be made available that not only comprises the bright window areas, but also wall segments that are illuminated with daylight such that the luminance contrast between the window areas and the surrounding wall segments is reduced on the one hand and the overall light input is increased on the other hand. For example, the region of the wall construction in front of the rib 102 is realized with a translucent material 106 in order to achieve a largely uniform illumination. FIG. 16 shows an exemplary embodiment, in which a light output opening 110 is arranged above a window 108. The light output opening 110 can be closed with a cover element for example, a panel segment 112, e.g. by vertically gliding the cover element.

To this end, FIG. 16 shows an inside view of a cabin wall section, in which an uncovered light output opening is illustrated in the left half and a covered light output opening is illustrated in the right half. For example, the cabin panel segment 112 may be combined with a likewise displaceable optical frame segment, i.e., a lining segment, of the window as illustrated in FIG. 16 in the form of an enlarged gap in the center of the window that is identified by reference symbol 114.

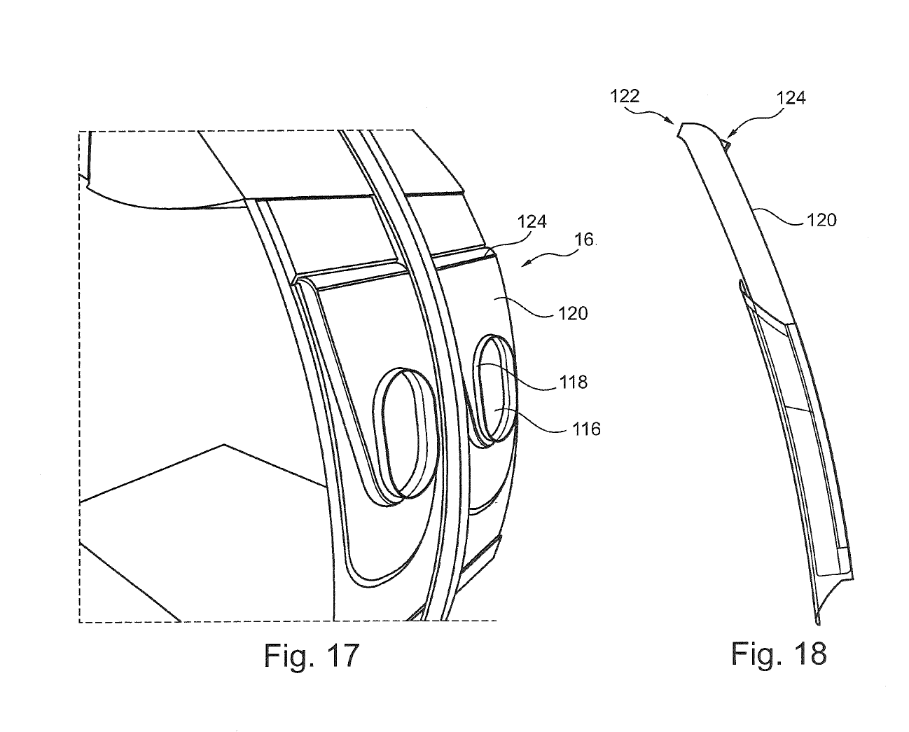

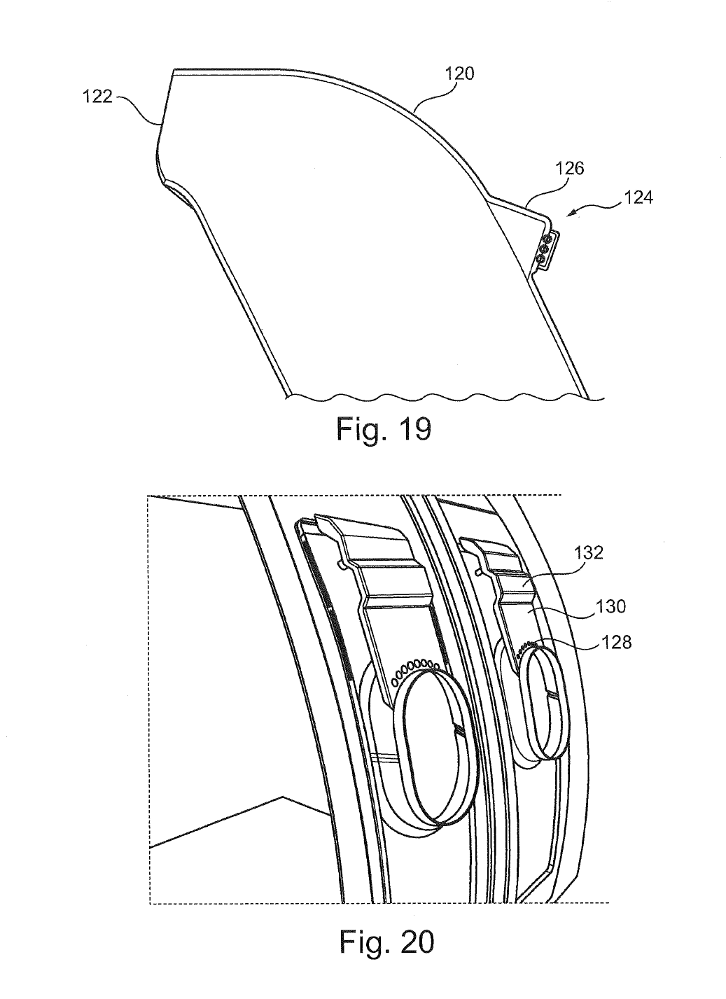

FIG. 17 shows another exemplary embodiment of the daylight input system 16 in the form of a schematic outside view, wherein the outer paneling layers and fuselage construction layers are not illustrated. According to FIG. 17, areas 118 for the irradiation of daylight, i.e., light receiving areas of the light receiving device 36, are arranged in the regions laterally of and above the windows 116. These areas are coupled to a light guiding element 120 of the light guiding device 38. FIG. 18 shows in the form of a vertical section that this light guiding element consists, for example, of a cavity with a reflective coating, by which the irradiated daylight is guided vertically upward within the wall construction. This can be realized with simple and lightweight measures. A light output unit 122 is situated on the upper end. In addition, an artificial light source 124 is arranged such that the artificial light source 124 can emit artificial light into the interior by the light output unit 122. To this end, the light guiding element 120 is illustrated in the form of an enlarged detail in the upper region in FIG. 19. For example, the artificial light source 124 is realized in the form of an LED light source in a lateral expansion 126, wherein light can be emitted in the direction of the light output unit 122 by said LED device. For example, the light output unit 122 may feature a translucent cover or even a cover element with additional light guiding measures such as, e.g., different beveled areas in order to deflect or diffuse light in different directions.

It should be noted that, according to the invention, the combination with artificial light sources can also be realized in the other exemplary embodiments, i.e., the combination with artificial light is by no means restricted to the examples, in reference to which this combination is explicitly mentioned.

FIG. 20 shows another exemplary embodiment of the daylight input system 16 in the form of a perspective outside view, wherein the outer layers are not illustrated. For example, several light receiving elements 128 are arranged above the window opening and couple daylight into a flat light guiding device 130 that, for example, may feature an offset 132 in order to bypass a horizontally extending structure in this area. However, it should be noted that this offset 132 is not an imperative component of the exemplary embodiment.

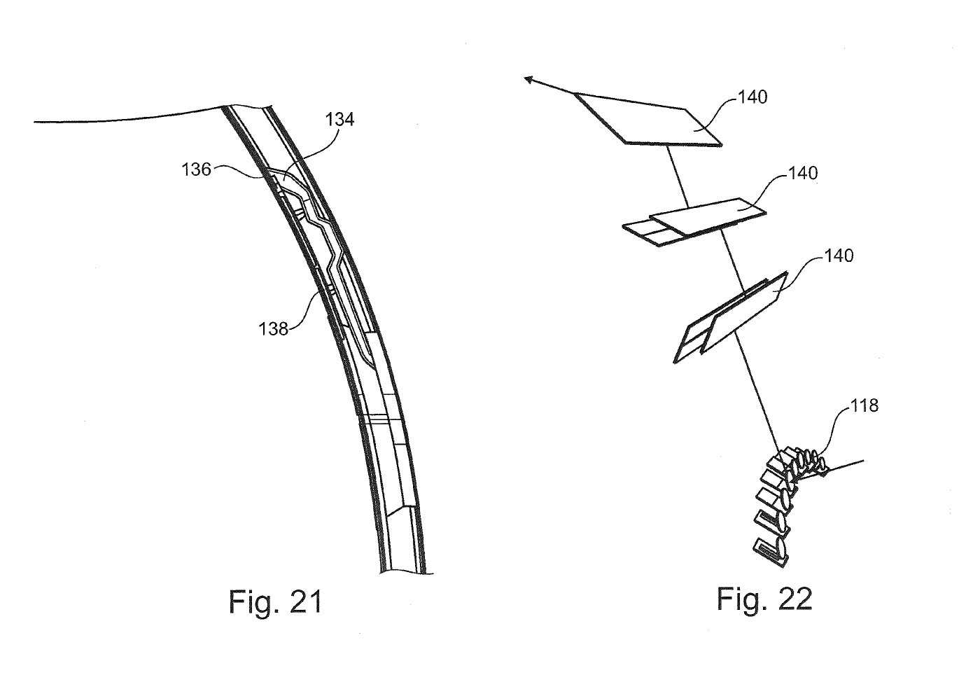

FIG. 21 shows in the form of a vertical section that an upper end 134 of the light guiding device 130 forms a light output opening 136 in the region of the cabin wall. Since the light guiding device 38 extends at a distance from the inner cabin wall over a large part of the vertical extent, a window cover element 138 may be provided in this area in order to temporarily close the window opening. The cover element 138 consists, for example, of a vertically slidable panel segment. In FIG. 22, the optical system with the light irradiating elements 118 is schematically illustrated in connection with several reflection areas 140.

It was already mentioned above that, according to an exemplary embodiment, the daylight entry through the window opening can be controlled independently of the emission of daylight by the light emitting device. Instead of a darkening element in the form of a slidable segment, it would also be possible to provide a pane, the light transmittance of which can be controlled, such as, for example, a pane of electrochromic glass.

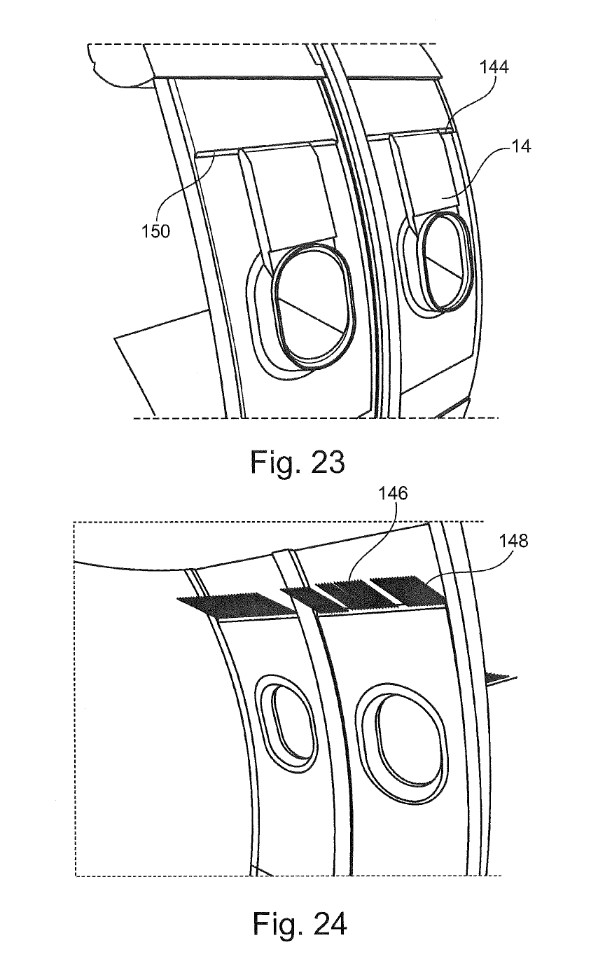

FIG. 23 shows another exemplary embodiment, in which the daylight input only takes place in an upper area of the window border and a vertically coupled light guiding area 142 leads into a horizontal light emitting area 144.

FIG. 24 shows the daylight input system according to FIG. 23 in the form of a view from the interior area. The input daylight is indicated with a first light structure 146 and an artificial light arranged in the areas laterally of the daylight input is indicated with a second light structure 148. To this end, it would be possible, for example, to arrange artificial light sources 150 adjacent to the light guiding area 142 in the region of the output opening.

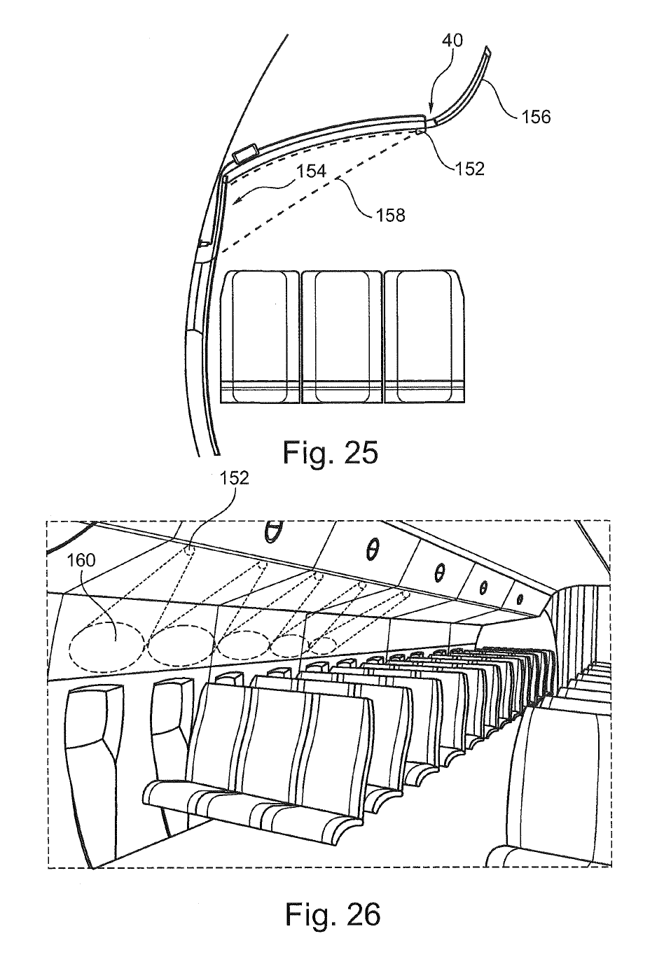

FIG. 25 shows another exemplary embodiment, in which the light emitting device in the form of projection units 152 is arranged in the interior such that an inner side 154 of the outer wall can be irradiated with the light to be emitted. For example, the light receiving device 40 is arranged on a luggage compartment lining segment 156 above the passenger seats in the direction of the aisle such that an area situated above the window can be irradiated with input daylight that is indicated with a structure 158 drawn with broken lines.

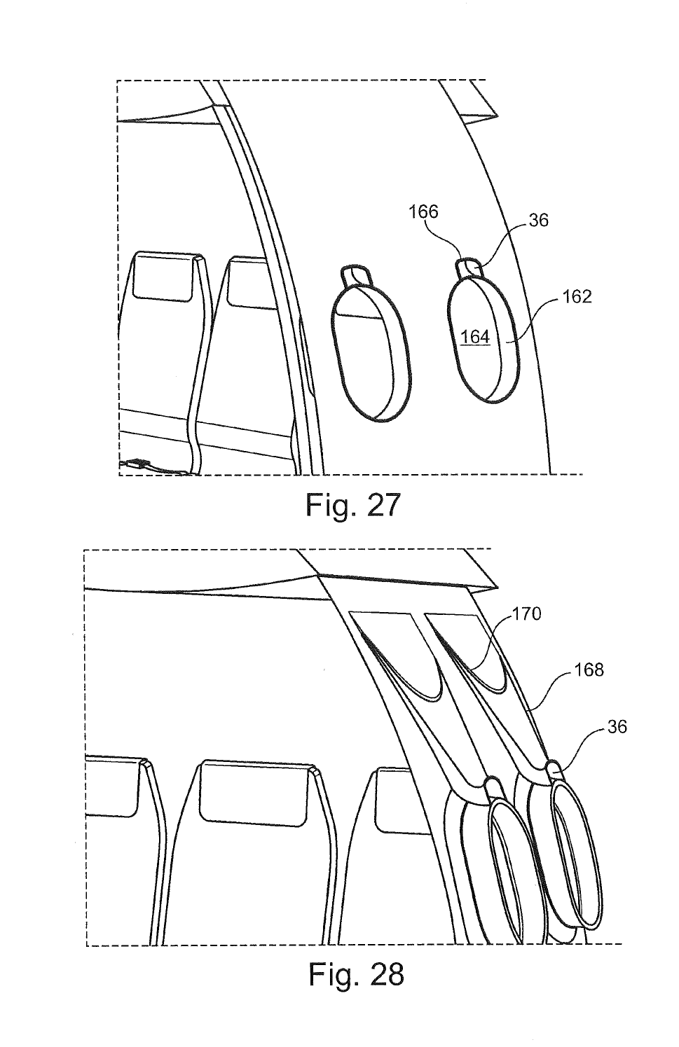

FIG. 26 shows an exemplary embodiment, in which several light emitting devices are arranged above the passenger seats in such a way that the wall zone above the window zone can be illuminated with daylight what means an altogether brighter cabin area, and furthermore also avoids dark wall segments of the cabin paneling. The illuminated wall region is schematically identified by reference symbol 160.

FIG. 27 shows an exemplary embodiment in which a window construction 162 is inserted into an opening 164 of the outer wall, wherein the light receiving device 36 is arranged in an expansion 166 of the opening 164. For example, the expansion 166 is arranged above the window opening and is significantly smaller than the window opening, e.g. smaller than 25% or smaller than 10% of the window surface.

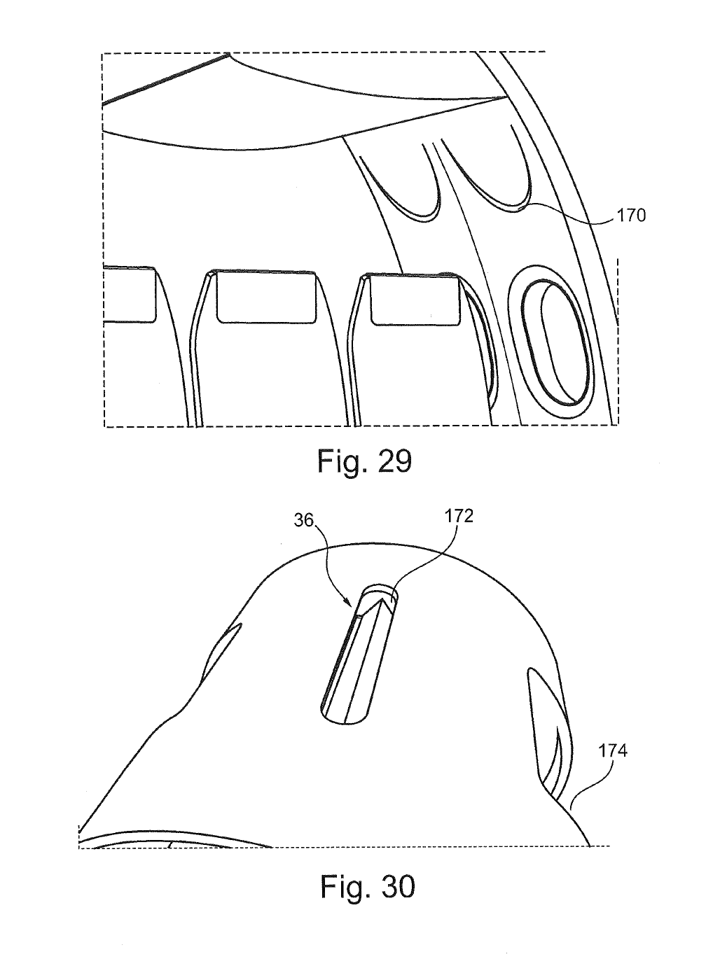

FIG. 27 schematically shows a perspective outside view while the outer cover layer is omitted in FIG. 28. As can be seen, an upwardly widening light guiding element that is coupled to the light receiving device 36 and that is simultaneously tapered with respect to its depth or thickness, wherein said light guiding element is identified by reference symbol 168. The light emitting device 40 may be realized, for example, in the form of an arc-shaped area 170 as illustrated in the form of a perspective interior view in FIG. 29.

In FIG. 30, an exemplary embodiment is shown, in which the light receiving device 36 of the daylight input system 16 comprises at least one light receiving opening 172 that is arranged in the enveloping surface, i.e., in the fuselage construction, wherein the daylight reaches the light guiding device arranged on the inner side through said light receiving opening 172.

For example, the light receiving opening 172 is arranged on the upper side of the fuselage construction, for example in the crown or apex area thereof. Two lateral door openings 174 are furthermore illustrated in FIG. 30.

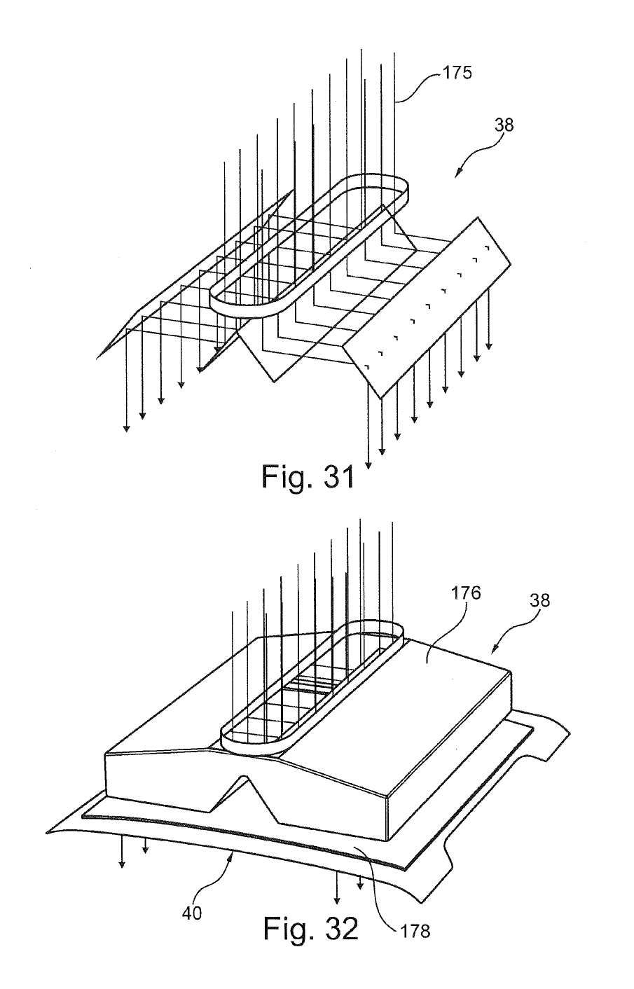

Since structural measures extending in the longitudinal direction such as, for example, supply lines are frequently located on the inner side of the enveloping surface in the centrally positioned apex area, the light guiding device 38 is realized in such a way that a portion of the incident daylight that is indicated with a light structure 175 in FIG. 31 is deflected toward one side and another portion is deflected toward the other side. FIG. 31 shows the corresponding optical principle. FIG. 32 additionally shows an envelope 176 of the light guiding device 38, as well as a lower translucent cover 178 provided for the light emitting device 40.

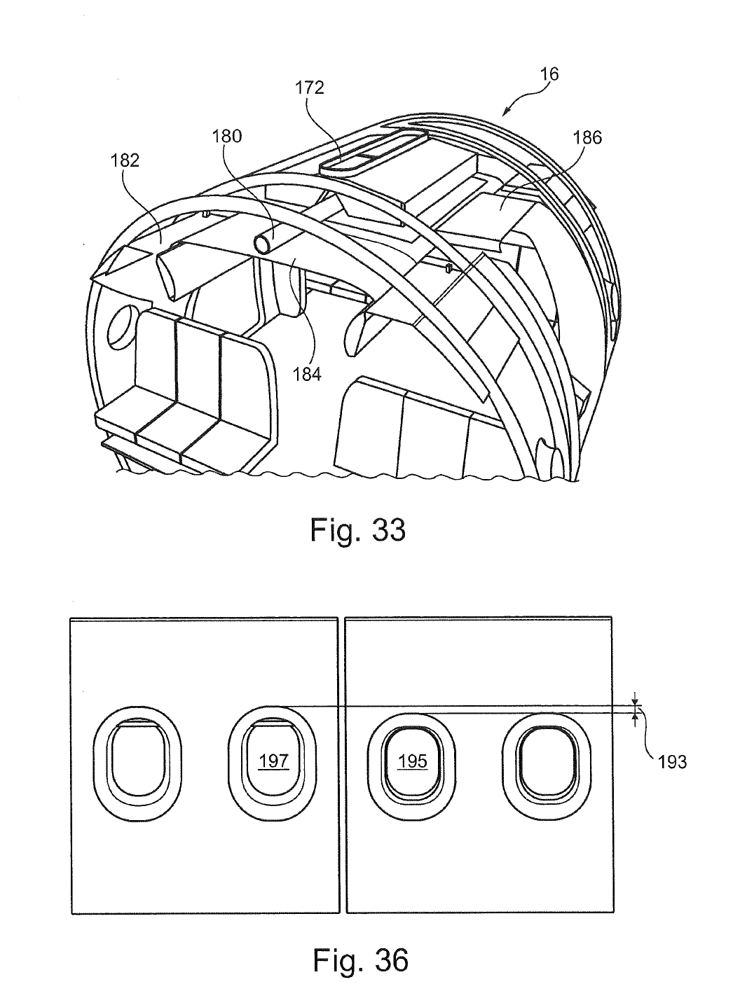

The daylight input system 16 described above with reference to FIGS. 30 to 32 is illustrated in the form of a perspective construction drawing in FIG. 33, namely in connection with the other components such as, for example, a horizontally extending supply 180, luggage compartment structures 182 provided in the overhead area of the passengers, upper ceiling panels 184 or door walls 186. The exemplary embodiment illustrated in FIGS. 30 to 33 makes it possible to additionally illuminate the central floor area situated adjacent to the entrance zone of the door opening from above, what means savings of artificial light.

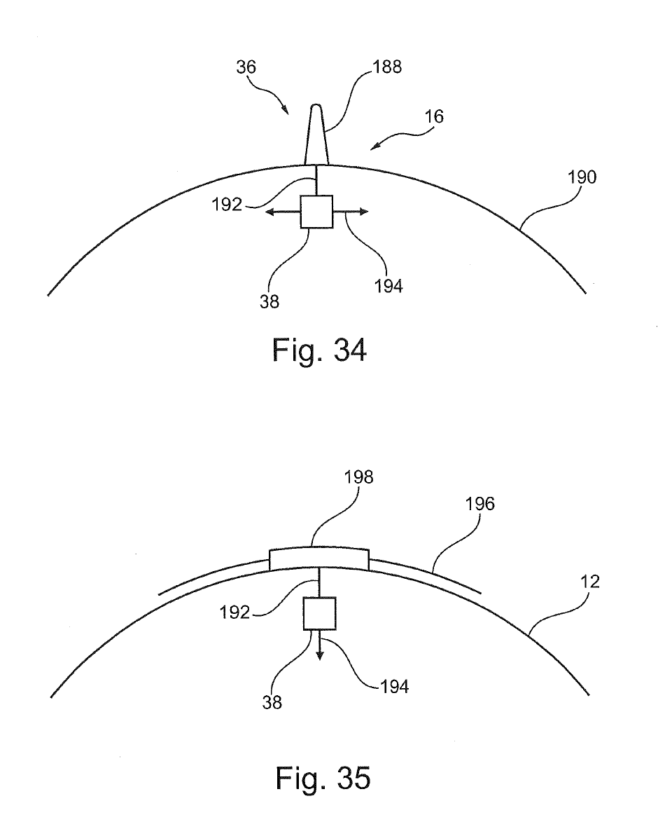

In FIG. 34, another exemplary embodiment of the inventive daylight input system 16 is shown, in which the light receiving device 36 features at least one projection 188 that protrudes from the outer side of the aircraft, indicated with a line 190. The light receiving device is realized, for example, in the form of a fin or rib that extends in the longitudinal direction and comprises a receiving surface that is larger than the contact surface of the rib on the outer wall surface. In FIG. 34, the connecting line 192 schematically indicates that the “captured” daylight is coupled into the light guiding device 38 and then guided to a light emitting device as indicated with an arrow 194.

According to another exemplary embodiment that is illustrated in FIG. 35, it is arranged to provide the outer side of the fuselage 12 with a light guiding film 196 that is applied onto the outer side of the fuselage and connected to an optical coupler 198 that couples the light from the film into the light guiding device 38 in order to guide the daylight to the light emitting device 40. For example, the light guiding film may be applied in several segments along the upper region of the fuselage.

According to another exemplary embodiment, it is provided to arrange the light receiving device 36 above the window, however, within the window opening in the fuselage construction. In other words, the same opening in the fuselage is used and only the actual window opening, i.e., the look-through opening, is slightly reduced in order to accommodate the light receiving device 36. To this end, FIG. 36 shows the version of a window 197 used so far in the left region and the inventive version with a slightly smaller window area 195 in the right region. The difference is indicated with reference symbol 193. Both illustrations respectively show two adjacent windows viewed from the interior.

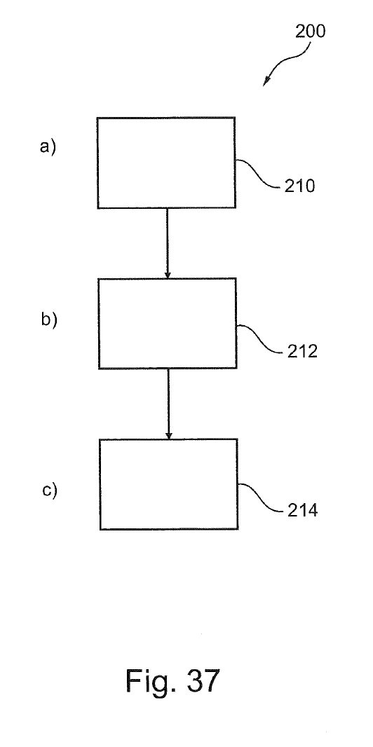

FIG. 37 shows a method 200 for utilizing daylight in the interior of an aircraft, wherein said method comprises the following steps: in a first step 210, a light guiding device is irradiated with daylight from the surroundings outside an outer wall by a light receiving device. In a second step 212, the irradiated light is guided to a light emitting device. In a third step 214, the daylight is emitted into an interior on an inner side of the outer wall. In this case, at least a partial deflection of the daylight takes place. The first step 210 is also referred to as step a), the second step 212 as step b) and the third step 214 as step c).

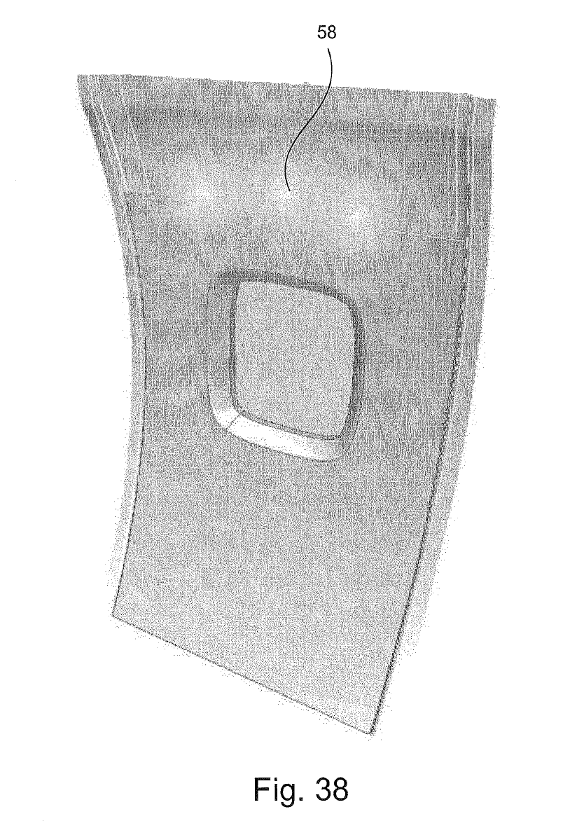

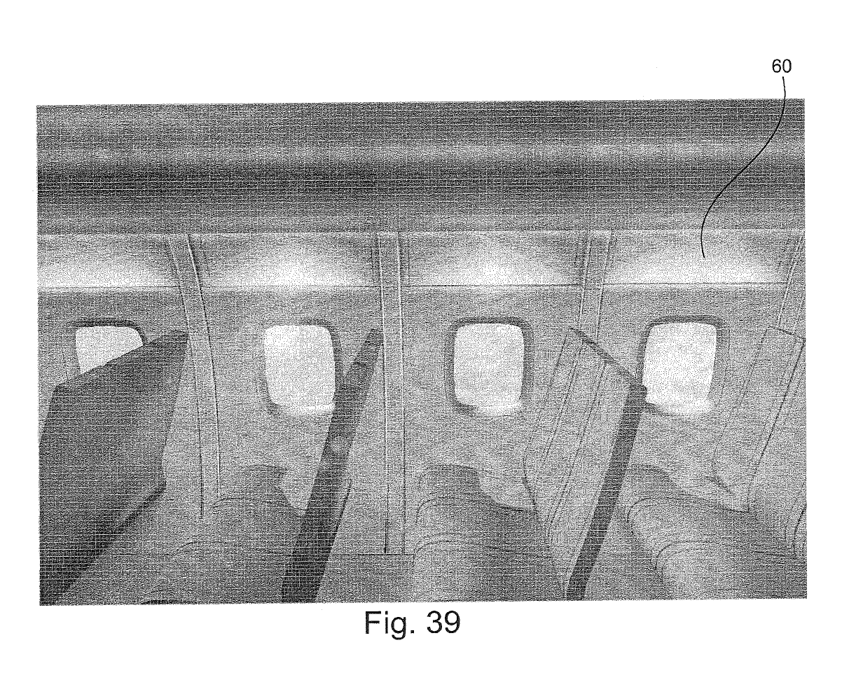

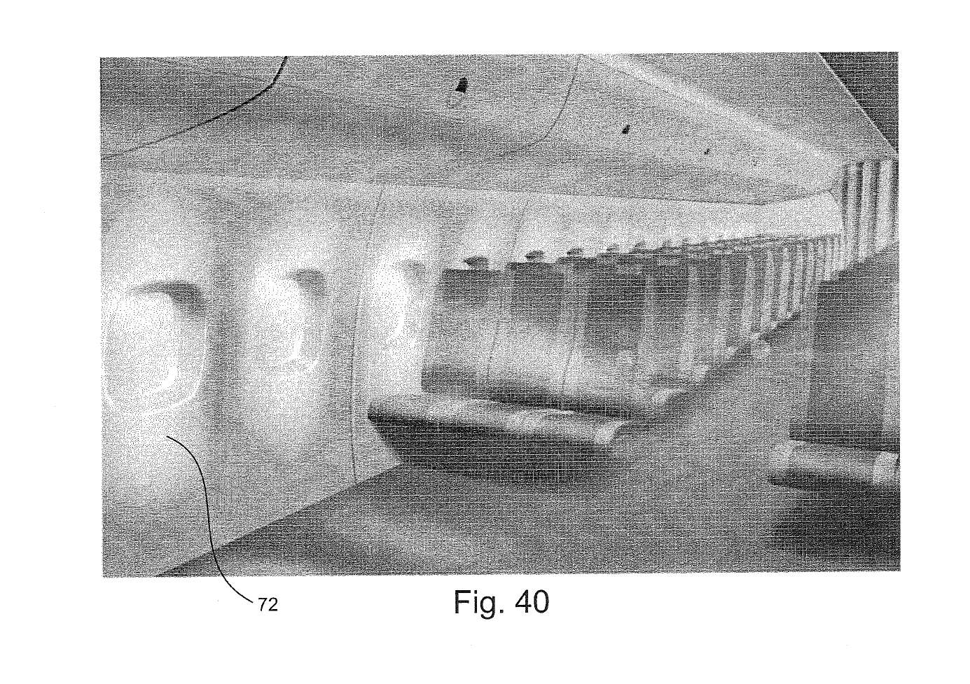

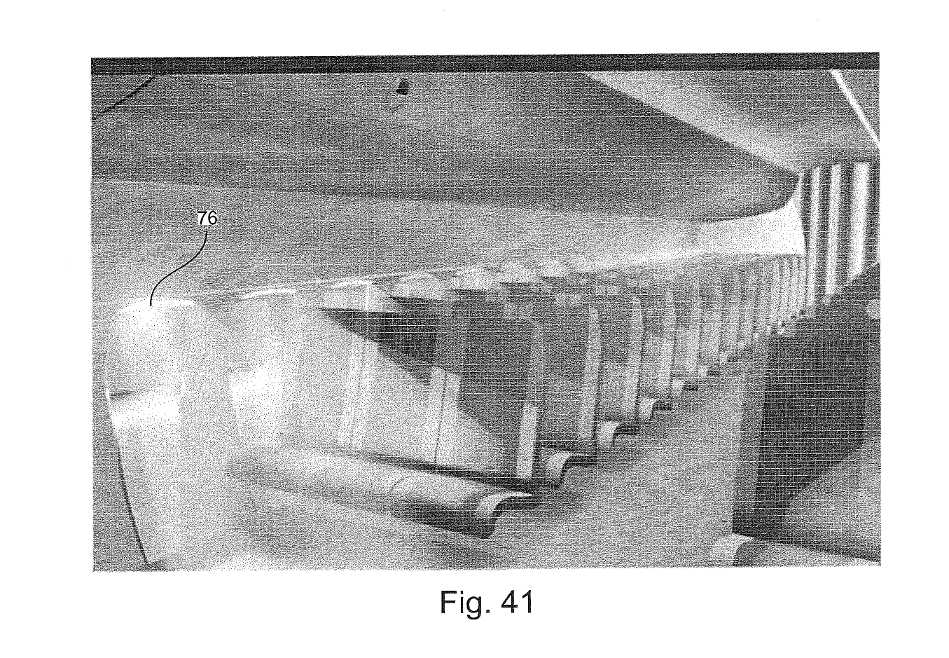

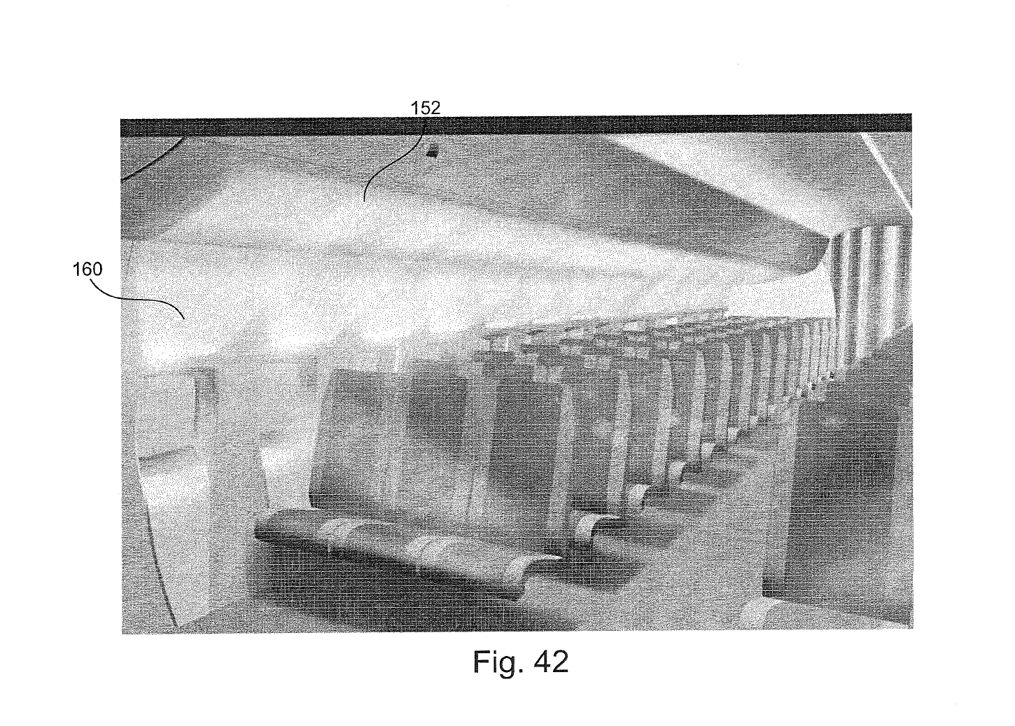

FIG. 38 shows a rendered illustration of the drawing in FIG. 4 and FIG. 39 shows a rendered illustration of FIG. 5. In addition, FIG. 40 shows a rendered illustration of FIG. 8 and FIG. 41 shows a rendered illustration of FIG. 11. Finally, FIG. 42 shows a rendered illustration of FIG. 26. The illustrations are respectively provided with the corresponding reference symbols.

According to other exemplary embodiments of the method, a combination of the characteristics that were described above in connection with the system is proposed as a supplement and expansion of the basic steps of the method according to FIG. 37. However, these other combination options are not illustrated in greater detail and include, for example, the input in border areas of a window construction and the deflection of daylight within the wall construction, for example to areas situated above windows, as well as the corresponding emission of the daylight at these locations, for example, in the form of diffuse reflections, i.e., scattering reflections, or by translucent areas illuminated from the rear. For example, a combination with the projection of daylight on visible surfaces or even a large-surface projection from the rear in areas around a window opening or a purposeful projection into areas between the windows is also provided, wherein the existing ribs so-to-speak provide the cabin wall with a certain rhythm in the form of illuminated, vertically extending wall surfaces.

The above-described exemplary embodiments can be combined in different ways. Aspects of the method may, in particular, also be realized in embodiments of the system, as well as in the embodiments of the utilization of the system, and vice versa.

As a supplement, it should be noted that “comprising” does not exclude any other elements or steps and that “a” or “an” does not exclude a plurality. It should furthermore be noted that characteristics or steps that were described with reference to one of the above exemplary embodiments and aspects can also be used in combination with other characteristics or steps of other above-described exemplary embodiments and aspects. This may result in other synergy effects that are not described. Reference symbols in the claims should not be interpreted in a restrictive sense.

1. An aircraft with a fuselage construction and at least one interior area arranged within the fuselage construction, and a daylight input system,
wherein the daylight input system comprises:
at least one light receiving device arranged in an outer wall;
at least one light guiding device; and
at least one light emitting device arranged on the inner side;
wherein the light receiving device is configured to receive daylight present in the surrounding outside the outer wall and transmit the received daylight into the light guiding device;
wherein the light guiding device is configured to optically couple the light receiving device to the light emitting device; and
wherein the light emitting device is configured to emit the received daylight into an interior space on an inner side of a wall construction.

2. The aircraft of claim 1, wherein the light guiding device of the daylight input system extends in a wall construction between the outer side and the inner side; and
wherein the light receiving device and the light emitting device are arranged offset to one another.

3. The aircraft of claim 1, further comprising a window construction inserted into an opening of the outer wall; and
wherein the light receiving device is arranged in the opening.

4. The aircraft of claim 3, wherein the window construction comprises an outer receiving surface larger than a look-through surface of the window by a projecting area; and
wherein the light receiving device is provided in the projecting area.

5. The aircraft of claim 1, wherein the light receiving device of the daylight input system couples a first portion of an incident daylight into the light guiding device and a second portion of the incident daylight reaches the interior through the window opening.

6. The aircraft of claim 1, wherein the light receiving device of the daylight input system is arranged in lateral border areas of adjacent windows; and
wherein a rib extends between the windows in vertical direction, and the light emitting device is arranged on the inner side in front of the rib.

7. The aircraft of claim 1, further comprising a window construction inserted into an opening of the outer wall; and
wherein the light receiving device is arranged in an expansion of the opening.

8. The aircraft of claim 1, wherein the light emitting device of the daylight input system forms a concealed light source.

9. The aircraft of claim 1, wherein the light emitting device of the daylight input system comprises a light output unit; and
wherein the light output unit is configured to be closed with a cover element.

10. The aircraft of claim 1, wherein the light emitting device of the daylight input system comprises a light output unit;
the aircraft further comprising an artificial light source arranged such that the artificial light source emits artificial light into the interior space by the light output unit.

11. The aircraft of claim 1, wherein the light emitting device of the daylight input system is arranged above the window.

12. The aircraft of claim 1, wherein daylight incident through the window opening is configured to be controlled independently of the emission of daylight by the light emitting device.

13. The aircraft of claim 1, wherein the light emitting device of the daylight input system is arranged in the interior such that an inner side of the outer wall is irradiated with the light to be emitted.

14. The aircraft of claim 1, wherein the light receiving device of the daylight input system comprises at least one light receiving opening inserted into the enveloping surface, through which opening the daylight reaches the light guiding device arranged on the inner side.

15. The aircraft of claim 1, wherein the light receiving device of the daylight input system comprises at least one projection protruding from the outer side of the aircraft.

16. The aircraft of claim 1, wherein the outer wall comprises a plurality of embedded light guides extending from the outer side to the inner side of the enveloping surface and coupling daylight into the light guiding device.

17. The aircraft of claim 1, wherein the light receiving device of the daylight input system comprises at least one light guiding film applied onto the outer side of the fuselage; and
wherein the film is connected to at least one optical coupling device coupling the light from the film into the light guiding device.

18. A method for utilizing daylight in the interior of an aircraft, the method comprising:
receiving daylight present in the surrounding outside an outer wall and transmitting the received daylight into a light guiding device by a light receiving device;
guiding the received daylight to a light emitting device; and
emitting the received daylight into an interior space on an inner side of the outer wall;
wherein at least a partial deflection of the daylight takes place.
